(19) United States
(12) Patent Application Publication
(10) Pub. No.: US 2006/0114454 A1
(43) Pub. Date: Jun. 1, 2006

(54) Optical claibration method

(76) Inventors: Tsung-Kai Chuang, Tai-Nan City (TW); Chien-Ho Chuang, Kao-Hsiung City (TW); Tzu-Chiang Wu, Miao-Li City (TW)

Correspondence Address: LIN & ASSOCIATES INTELLECTUAL PROPERTY, P.O. BOX 2339, SARATOGA, CA, 95070-0339, US

(21) Appl. No.: 11/002,847

(22) Filed: Dec. 1, 2004

(51) Int. Cl. G01N 21/00

(52) U.S. Cl. 356/239.2

(57) ABSTRACT

Disclosed is a method for calibrating an optical component, such as a DWDM, a thin film filter, a collimator, and a wave-guide. The method includes the steps of projecting a laser beam through the optical component, detecting the transmitting power while moving the optical component until the transmitting power is maximum to determine a local area, and detecting the reflected power while moving the optical component with fine steps within the local area until the reflected power is minimum, where an optimum point is located, which gives the maximum transmitting power and minimum reflected power.

### FIELD OF THE INVENTION

The present invention relates to a method for calibration of optical component, particularly Dense Wavelength Division Multiplexing (DWDM) components, including thin film filters, collimators, and wave-guides commonly used in the photoelectric industry, and in particular to a calibration method that detect both reflected power and transmitting power by/through the optical component to determine the optic characteristics of the optical component.

### BACKGROUND OF THE INVENTION

A light beam transmits through an optic component, such as a thin film filter, is incident onto a first surface, and then travel through the filter, which is often made of a light transmitting material, and eventually leaves the light transmitting material through an opposite second surface. According to Snell's law, the light beam incident onto the first surface is subject to reflection by the first surface whereby a portion of the light is reflected by the first surface while the remaining portion transmits through the second surface.

FIG. 1 of the attached drawings illustrates Snell's law applied to an interface between air and the optic component, such as thin film filter. A ray traveling through air is incident onto an interface between air and the thin film filter. A portion of the ray is reflected, while the other portion transmits into the thin film filter. Angles θi, θr, and θt represent an angle of incidence, an angle of reflection, and an angle of refraction, respectively. Refractive indexes of air and the material that makes the thin film filter are designated by n1 and n2, respectively. According to Snell's law, the following equations apply: (1) θi=θr and (2) n1 sin θi=n2 sin θt.

Optic calibration performed by detecting the power of light beam transmitting through an optic component is known, such as U.S. Pat. Nos. 5,666,450 and 6,205,266. These references teach to emit a light beam through the optic component and detecting the power transmitting through the optic component. By moving the optic component in a controlled manner, the position on the optical component where the transmitting power becomes a maximum can be determined.

On the other hand, using reflected power to determine the position where the power transmitting through the optical component is maximum is also known. The conventional manner is done by moving the light beam that is incident onto the optical component along a spiral locus. This is a time-consuming process.

The present invention is aimed to provide a method for calibrating an optic component in a time-efficient manner so as to overcome the drawback of the conventional methods.

### SUMMARY OF THE INVENTION

Thus, a primary objective of the present invention is to provide an optic calibration method that can determines optic characteristics of an optic component in a time-efficient manner.

Another objective of the present invention is to provide an optic calibration method that is performed by a computer-based system so as to completely eliminate human errors and thus enhancing quality and production yield.

A further objective of the present invention is to provide an optic calibration method that is comprised of an initial phase wherein power transmitting through the optic component is detected to roughly determine an optimum area where the transmitting power is maximum and a fine tuning phase wherein search is performed within the roughly determined area and power reflected from the optic component is detected to precisely determine an optimum position within the optimum area.

For more detailed information regarding advantages or features of the present invention, an example of a calibration system that perform the best mode of the calibration method in accordance with the present invention are both described in detail hereafter with reference to the attached, in which:

### BRIEF DESCRIPTION OF THE DRAWINGS

FIG. 1 a schematic view illustrating Snell's law;

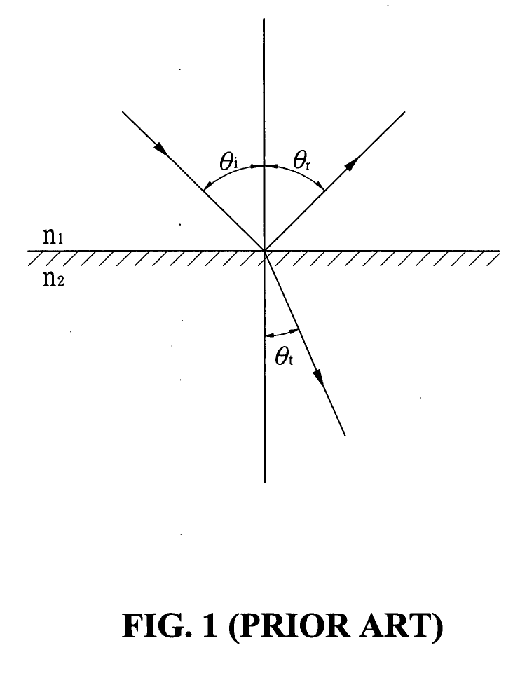

FIG. 2 a block diagram showing a calibration system for performing a calibration method in accordance with the present invention;

FIG. 3 is a schematic view showing spatial relationship between light transmitter and receiver of the calibration system for measuring power transmitting through an optic component and power reflected by the optic component;

FIG. 4 shows the general processing steps of the optical calibration method of the present invention;

FIG. 5 is a schematic view showing the permeability ratio of a laser beam vs. wavelength by utilizing the method of the present invention;

FIG. 6A shows a flowchart of the optic calibration method in accordance with the present invention; and

FIG. 6B is a continuation part of FIG. 6A.

### DETAILED DESCRIPTION OF THE BEST MODE FOR CARRYING OUT THE PRESENT INVENTION

The present invention discloses a method for calibrating an optical component, such as a DWDM filter, a thin film filter, a collimator, and a wave-guide, which is made of a light-transmitting material having first and second surfaces opposite to each other.

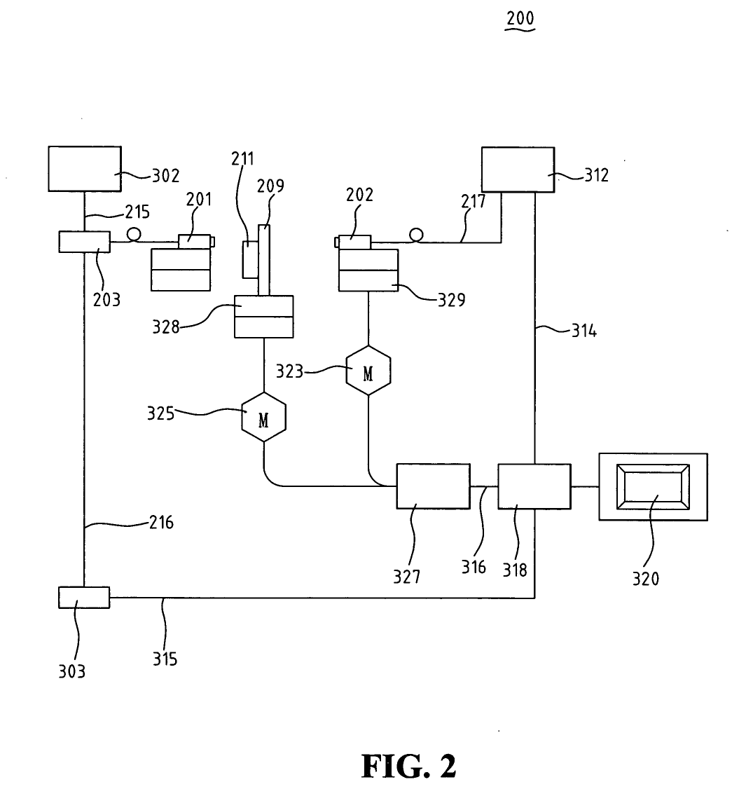

Referring to FIG. 2, the calibration of the optical component in accordance with the present invention is carried out with an optical calibration machine, generally designated with reference numeral 200, which consists of a movable platform 209 for carrying an optical component 211 to be calibrated, a transmitter 201 that is also movable for projecting a light beam or a ray onto the optical component 211, and a receiver 202 that is also movable for receiving the ray transmitting through the optical component 211.

The transmitter 201 and the receiver 202 are located on opposite sides of the platform 209 whereby the ray projecting from the transmitter 201 travels along an optical path through the optical component 211 and gets incident onto the receiver 202. A first optical fiber cable 215 connects the transmitter 201 to a light source 302, such as a tunable laser diode. A second optical fiber cable 217 connects the receiver 202 to a first power meter 312. Thus, the light source 302 emits a ray that travels along the first cable 215 to the transmitter 201, projecting from the transmitter 201, through the optical component 211, to receiver 202. A component of the ray is reflected by a first surface of the optical component 211, which will be referred to as “reflected component”, while the remaining of the ray transmits through the optical component 211 and reaches the receiver 202, which will be referred to as “transmitting component”.

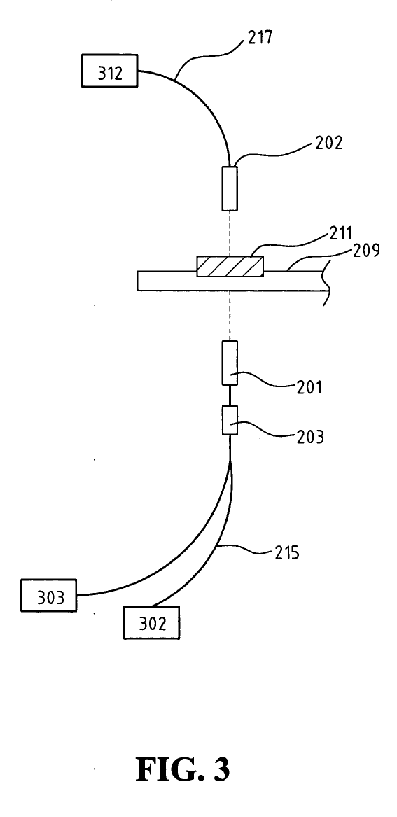

Also referring to FIG. 3, a coupler 203 that is coupled to a second power meter 303 by a fiber optic cable 216 is arranged between the transmitter 201 and the first cable 215 for directing the reflected component of the ray that is reflected back into and travels in reversed direction along the first cable 215 to the second power meter 303, which detects power P2 of the reflected component. The transmitting component is received by the receiver 202 and directed by the second cable 217 to the first power meter 312, which detects power PI of the transmitting component.

In response to the detection of power P1 of the transmitting component, the first power meter 312 generates a signal representing a measured value of power P1, which is applied to a computer or a microprocessor based device 318 via a general purpose interface bus (GPIB) 314. Similarly, the power P2 of the reflected component, which is detected by the second power meter 303, is also applied to the computer 318 by a GPIB 315. The computer 318 is connected to a monitor 320, which selectively displays the transmitting power P1 and the reflected power P2.

The computer 318 is connected via a GPIB 316 to a motor controller 327, which controls motors 323, 325, such as stepping motors, respectively coupled to and driving carriers 328, 329 that carry and move the platform 209 and the receiver 202, respectively. If desired, an additional motor (not shown), also coupled to and controlled by the motor controller 327, may be provided for driving a carrier 330 that carries and moves the transmitter 201.

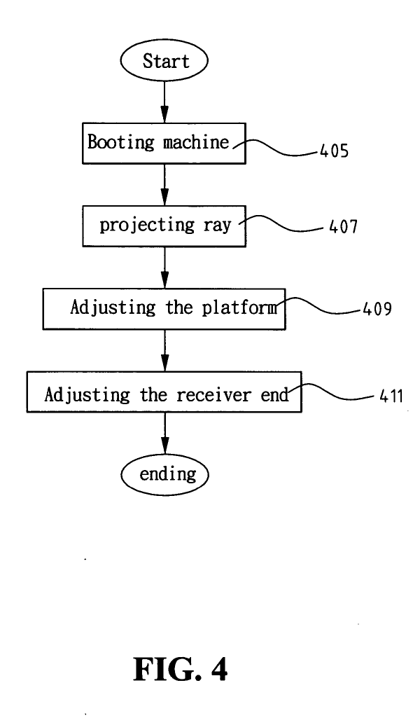

FIG. 4 shows general processing steps of the optical calibration method in accordance with the present invention, which starts by booting the calibration machine 200 for loading software and initializing drivers, step 405, followed by a step (step 407) of projecting a ray from the transmitter 201 to the receiver 202 through the optical component 211. Thereafter, the position of the optical component 211 is adjusted by moving the platform 209 with the stepping motor 325, step 409. If necessary, the position of the receiver 202 may be adjusted by moving the carrier 329 with the motor 323, step 411.

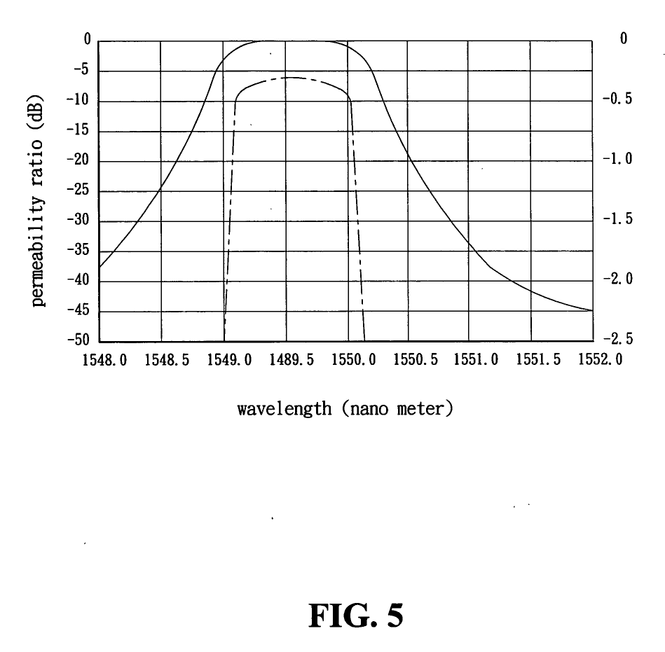

The ray projecting through the optical component is received by the receiver 202 and a spectrum can be obtained. An example of the spectrum received is illustrated in FIG. 5, plotted as a curved of the received permeable ratio of the ray vs. wavelength. The solid line encloses the power measured by a power meter, and the attenuation thereof is logarithmic and represented by permeable ratio (dB) in ordinate (the vertical axis of the drawing). Power attenuation can be obtained according to the formula: dB=10 log[P/1 mW]. For example, an attenuation of power to 50% (0.5 mW) indicates a mean power attenuation of −3 dB, and 10% means −10 dB attenuation.

Abscissa (the horizontal axis) represents light wavelength (nm). The dotted line encloses an enlarged view of wavelengths between 1550.0 nm and 1550.2 nm.

The spectrum is delimited by opposite extreme points, which are the left and right boundary of the spectrum diagram illustrated in FIG. 5. A center wavelength indicates the highest ridge point of the spectrum. The method of the present invention is carried out by moving the optical component 211 with respect to the incident ray in a step by step manner whereby the ray gets incident onto different spot on the first surface of the optical component 21 and detect the transmitting component of the ray by the receiver 202. Once the incident spot is approaching an optimum position where the incident ray gets the greater transmitting power, the center wavelength moves toward one of the extremes of the spectrum. This process determines a limited local area within which the optimum position is located.

Once the local area is determined, a fine calibration is performed, which detects the reflected power with the second power meter 303 with the incident spot moved within the local area along a spiral locus. Detection of the maximum reflected power indicates the “true” optimum position of the optical component 211 and the calibration is completed.

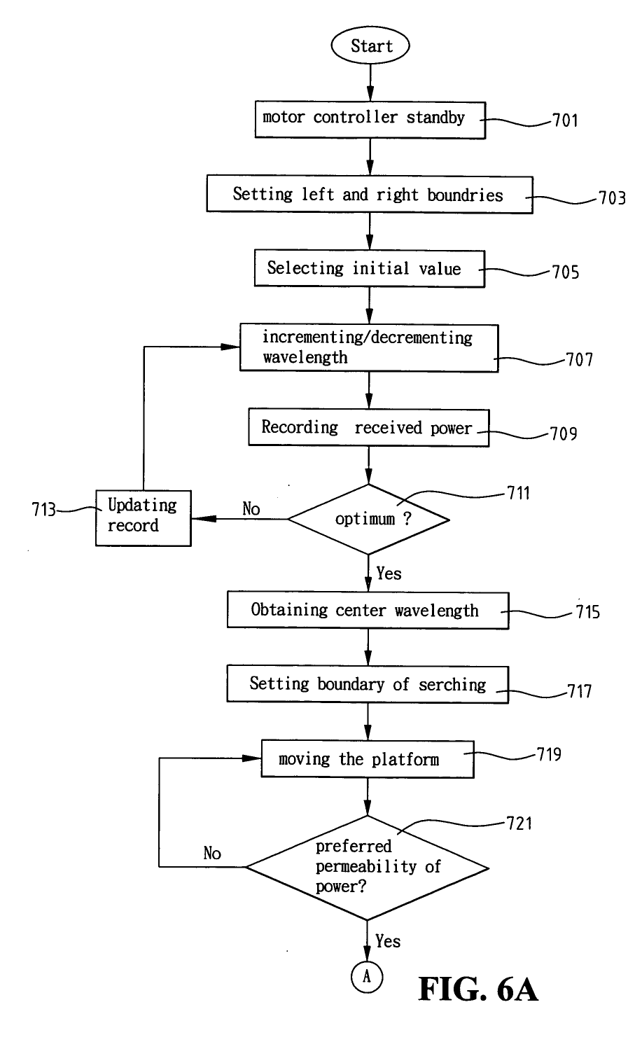

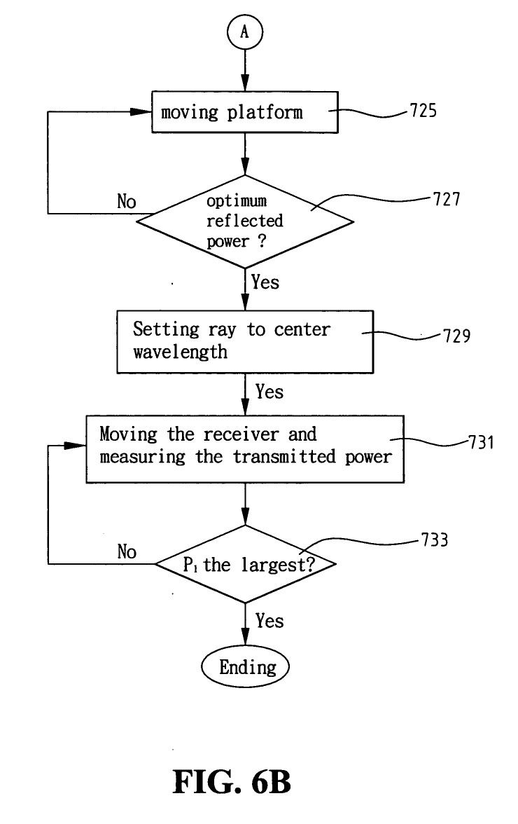

FIGS. 6A and 6B show a flowchart of the calibration method in accordance with the present invention. The method is performed with the optical component 211 to be calibrated mounted on the platform 209 and the transmitter 201 projects a ray through the optical component 211 to the receiver 202. The method starts with a step of setting the motor controller 327 in a stand-by state (step 701). In step 703, extremes (left and right boundaries) of the frequency spectrum are set for a fast search of optimum wavelengths for calibration, and an initial value is selected from the range between the boundaries, which is usually one of the boundaries, step 705. The wavelength is changed constantly by an infinitesimal amount from the initial value by incrementing/decrementing the initial value, step 707. The transmitting power received by the receiver 202 is recorded, step 709. In step 711, the currently received transmitting power is compared with a previous record. If the currently received transmitting power is larger than the previous record, the previous record is replaced by the currently detected value, step 713, and the process goes back to step 707 to increment/decrement the wavelength. If the currently received transmitting power is smaller than the previous record, the previous record is “optimum” and the optimum wavelength is determined, step 715.

After the optimum wavelength is determined, a boundary of search is set, step 717 and a search starts. In step 719, the position of the optical component 211 is changed by moving the platform 209 in a step-by-step manner. In each step, the transmitting power is detected and compared, step 721, until a preferred value is obtained. This determines the local area within which the optimum position is located.

Once the local area is determined, the platform 209 is moved with respect to the transmitter 201 and the receiver 202, preferably in such a manner that the incident spot of the ray on the optical component moves along a spiral locus, step 725. Reflected power is detected and process repeated until a preferred value of the reflected power is obtained, step 727.

If desired, additional steps may be performed. In steps 729, the ray is set to the center wavelength. In step 731, the receiver 202 is moved, and the transmitted power is detect. The process is repeated until the largest transmitting power is found, step 733. Then, the process is completed.

The present invention has been described with the best mode thereof with reference to the drawings and it is apparent that numerous changes or modifications may be made without departing from the true spirit and scope thereof, as set forth in the claims below.

What is claimed is:

1. A method for calibrating an optical component made of light transmitting material comprising the following steps:
(1) projecting a ray through the optical component;
(2) detecting a transmitting power of the ray and making a first record of the transmitting power;
(3) moving the optical component in a given direction;
(4) detecting the transmitting power again and making a second record of the transmitting power;
(5) comparing the second record with the first record;
(6) determining a local area and going to step (7), if the second record is smaller than the first record; otherwise replacing the first record with the second record and going back to step (3);
(7) detecting a reflected power and making a third record of the reflected power;
(8) causing the optical component to move a step in a given locus;
(9) detecting the reflected power again and making a fourth record of the reflected power;
(10) comparing the fourth record with the third record; and
(11) determining an optimum position, if the fourth record is larger than the third record; otherwise replacing the third record with the fourth record and going back to step (8).

2. The method as claimed in claim 1 further comprising, before step (1), a step of providing a tunable laser as a light source to project the ray through the optical component.

3. The method as claimed in claim 1 further comprising a step of providing a movable platform for carrying the optical component and a step of providing a driving device to move the movable platform in the given direction.

4. The method as claimed in claim 1, wherein the optical component comprises a dense wavelength division multiplexer filter.

5. The method as claimed in claim 1, wherein the optical component comprises a thin film filter.

6. The method as claimed in claim 1, wherein the optical component comprises a collimator.

7. The method as claimed in claim 1, wherein the optical component comprises a wave-guide.
